(19) United States
(12) Patent Application Publication
(10) Pub. No.: US 2022/0341477 A1
(43) Pub. Date: Oct. 27, 2022

(54) Filter Housing for a Brake Dust Particle Filter

(71) Applicant: MANN+HUMMEL GmbH, Ludwigsburg (DE)

(72) Inventors: Tobias Woerz, Leutenbach (DE); Thomas Jessberger, Asperg (DE); Lukas Bock, Bietigheim-Bissingen (DE); Volker Kuemmerling, Bietigheim-Bissingen (DE); Coskun Evlekli, Waiblingen (DE)

(21) Appl. No.: 17/861,880

(22) Filed: Jul. 11, 2022

Related U.S. Application Data
(63) Continuation of application No. PCT/EP2021/050049, filed on Jan. 5, 2021.

(30) Foreign Application Priority Data
Jan. 9, 2020 (DE) 102020100346.3

(51) Int. Cl. F16D 65/00

(52) U.S. Cl. CPC F16D 65/0031; F16D 55/22

(57) ABSTRACT

A ring segment-shaped filter housing of a brake dust particle filter of a disc brake has a first housing part with two or more first shell pieces connected to each other. The first shell pieces overlap in circumferential direction in an overlap region, respectively, and are connected to each other in the overlap region. At least one of the first shell pieces has circumferential end regions mirror-symmetrical to each other. A filter housing assembly set for producing such a filter housing has two or more shell pieces connectable to each other, wherein at least one of the shell pieces has circumferential end regions mirror-symmetrical to each other, wherein the shell pieces are designed to overlap in circumferential direction in an overlap region and to be connected to each other in the overlap region. A brake dust particle filter and a disc brake with such a filter housing are provided.

### CROSS-REFERENCE TO RELATED APPLICATIONS

This application is a continuation application of international application No. PCT/EP2021/050049 having an international filing date of 5 Jan. 2021 and designating the United States, the international application claiming a priority date of 9 Jan. 2020 based on prior filed German patent application No. 10 2020 100 346.3, the entire contents of the aforesaid international application and the aforesaid German patent application being incorporated herein by reference.

### BACKGROUND OF THE INVENTION

The invention relates to a ring segment-shaped filter housing for a brake dust particle filter for collecting brake dust of a disc brake.

WO 2019/048374 A1 describes a brake dust particle filter for collecting brake dust of a disc brake of a vehicle. The brake dust particle filter comprises a ring segment-shaped filter housing which is comprised of two housing half shells and, as a filter medium, accommodates a filter insert at which the brake dust is deposited. The filter housing including the filter insert comprises a U-shaped cross section shape and engages across the outer edge of the brake disc. The disc brake is received in a wheel bearing housing at which the filter housing of the brake dust particle filter is fastened.

### SUMMARY OF THE INVENTION

It is the object of the invention to create a ring segment-shaped filter housing for a brake dust particle filter that can be adapted to various installation situations with simple measures.

This object is solved according to the invention in that at least one housing part of the filter housing is comprised of at least two shell pieces that are connected to each other and wherein at least one shell piece comprises circumferential end regions that are embodied mirror-symmetrically to each other, wherein the at least two shell pieces overlap each other in circumferential direction and are connected to each other in the overlap region, in particular are welded.

The dependent claims provide expedient further embodiments.

The ring segment-shaped filter housing according to the invention can be employed in brake dust particle filters that are used for collecting brake dust of a disc brake, in particular in vehicles. The brake dust is produced upon actuation of the disc brake by the friction between the brake pad and the brake disc and is caught by the brake dust particle filter which accommodates a filter insert of a filter material in a ring segment-shaped filter housing. Advantageously, the filter housing as well as the filter insert accommodated therein comprise a U-shaped cross section shape wherein the brake dust particle filter is placed with the open side of the U onto the brake disc so that the radial outer side of the brake disc is partially engaged across by the U-shape of the brake dust particle filter. The brake dust that is generated upon actuation of the disc brake by abrasion of the brake pads at the brake disc is tangentially thrown outwardly and is caught by the brake dust particle filter. The terms “radial”, “axial”, and “tangential” relate to, if nothing to the contrary is indicated, the axis of rotation of the brake disc.

The ring segment-shaped filter housing comprises at least one housing part that is comprised of at least two shell pieces that are connected to each other. At least one shell piece comprises circumferential end regions that are embodied mirror-symmetrically to each other.

Due to the mirror symmetry of the at least one shell piece, it is possible to arrange this shell piece in a position inverted by 180° which enables a use on two different disc brakes that are arranged mirror-symmetrically to each other. This makes it possible to assemble a filter housing for a brake dust particle filter from a few building blocks and to employ this filter housing, depending on the composition, either at the disc brake at a left vehicle wheel or at the disc brake at a right vehicle wheel which are arranged mirror-symmetrically to each other. The filter housing for the brake dust filter at the left vehicle wheel and at the right vehicle wheel comprise the same components which are only assembled in different ways.

The plane of symmetry of the mirror symmetry of the at least one shell piece is preferably a plane that contains the axis of rotation of the brake disc in a mounted state of the brake dust particle filter and that extends in radial direction.

In particular in the case of small production runs with a relatively small number of vehicles, this procedure enables a wheel-specific adaptation of the filter housings at relatively minimal costs. A use is conceivable in particular in cases in which a left and a right housing part of the filter housing differ from each other. For a mirror-symmetrical arrangement, it is necessary to mirror-symmetrically configure the left housing part of the brake dust particle filter that is arranged to the left in relation to the housing part arranged to the right of the brake dust particle filter positioned to the right. The same holds true for the right housing part at the brake dust particle filter arranged to the left and the left housing part at the brake dust particle filter arranged to the right.

The at least one housing part that is comprised of at least two shell pieces forms at least partially a side wall of the filter housing in a preferred embodiment. Preferably, in this context one of the mirror-symmetrical circumferential end regions of a shell piece forms a circumferential end piece of the side wall.

According to a particularly preferred embodiment, the circumferential end regions of the at least one shell piece that are embodied mirror-symmetrically to each other comprise an interface geometry corresponding to a predetermined brake caliper of a disc brake assembly. In this way, from the same components of the filter housing, a filter housing suitable selectively for connection to a left and right brake caliper can be obtained. Interface geometry is to be understood as a structural configuration of the filter housing that is following the contour of the brake caliper in the plane of the wall of the filter housing so that gaps between the filter housing and the brake caliper can be kept as small as possible.

According to an advantageous embodiment, the filter housing is comprised of at least two housing parts that each form a housing half shell. At least one housing half shell is assembled from the at least two shell pieces. In a preferred embodiment, both housing half shells are each assembled of at least two shell pieces. It is furthermore advantageous that at least two shell pieces of the housing part each comprise mirror-symmetrically embodied circumferential end regions. In case of a division in two housing half shells, one of the housing half shells can comprise precisely two shell pieces and the other housing half shell three or more shell pieces which are arranged in circumferential direction lying one after another. In principle, it is however sufficient that per housing half shell precisely two shell pieces are provided that, depending on the arrangement of the brake dust particle filter in the left or right region, are assembled in different ways.

The assembly of the shell pieces is realized preferably in circumferential direction. The shell pieces are connected to each other, preferably fixedly and non-detachably connected, for example, by welding, soldering or gluing. Alternatively, also a detachable connection of the shell pieces is possible, for example, by means of screwing or the like.

In order to provide a permanent connection between the shell pieces that withstands the loads occurring in operation, it is expedient that two shell pieces which are connected to each other overlap each other in circumferential direction, wherein the connection is realized in the overlap region, in particular by welding or optionally by screwing or the like. Due to the overlapping embodiment, a relatively large region is available for producing the connection of the shell pieces.

The housing half shells which are assembled of the shell pieces, to respectively, can be connected to each other in order to form the ring segment-shaped filter housing. The connection between the housing half shells is realized either permanently, in particular by welding, or detachably, for example, by means of a detachable form-fit connection or by means of a screw connection.

The housing half shell which is comprised of at least two shell pieces comprises advantageously a side wall which extends parallel to the brake disc, as well as an outer circumferential side which in the mounted state is positioned concentrically to the outer rim of the brake disc. The connection between the two housing half shells is realized preferably by means of the outer circumferential side of the housing half shells, wherein the outer circumferential sides advantageously overlap each other axially.

The invention relates furthermore to a filter housing assembly set for producing the afore described filter housing. The filter housing assembly set comprises at least two shell pieces that are connectable to each other, wherein at least one shell piece comprises circumferential end regions that are embodied mirror-symmetrically to each other. In a further preferred embodiment, the filter housing assembly set comprises at least four shell pieces, wherein respectively at least two shell pieces form a housing half shell. In each housing half shell, there is at least one shell piece with circumferential end regions that are embodied mirror-symmetrically to each other.

The filter housing assembly set makes it possible to assemble and connect to each other the different shell pieces in different ways depending on the arrangement of the brake dust particle filter. Four or five shell pieces suffice in order to produce mirror-symmetrically embodied filter housings, for example, in the left and in the right lateral vehicle region.

A further aspect of the invention relates to a brake dust particle filter for collecting brake dust of a disc brake, wherein the brake dust particle filter comprises a ring segment-shaped filter housing that is embodied in the afore described manner as well as a filter insert of a filter material that is accommodated in the filter housing.

A further aspect of the invention concerns a disc brake assembly with a brake disc, a brake caliper, and a brake dust particle filter according to the invention which is arranged in a predetermined rotational direction downstream of the brake caliper in circumferential direction and engages across the brake disc at least in sections. The mirror-symmetrically embodied circumferential end regions of a shell piece of the filter housing of the brake dust particle filter comprise in this context an interface geometry corresponding with the brake caliper.

### BRIEF DESCRIPTION OF THE DRAWINGS

Further advantages and expedient embodiments can be taken from the additional claims, the figure description, and the drawings.

FIG. 1 shows a perspective view of a disc brake with a brake dust particle filter whose filter housing is embodied ring segment-shaped and is comprised of two housing half shells which comprise a plurality of shell pieces, respectively.

FIG. 2 shows the filter housing in individual view.

FIG. 3 shows the two housing half shells of the filter housing.

FIG. 4 shows the shell pieces of the first housing half shell.

FIG. 5 shows the shell pieces of the second housing half shell.

In the Figures, same components are provided with same reference characters.

### DESCRIPTION OF PREFERRED EMBODIMENTS

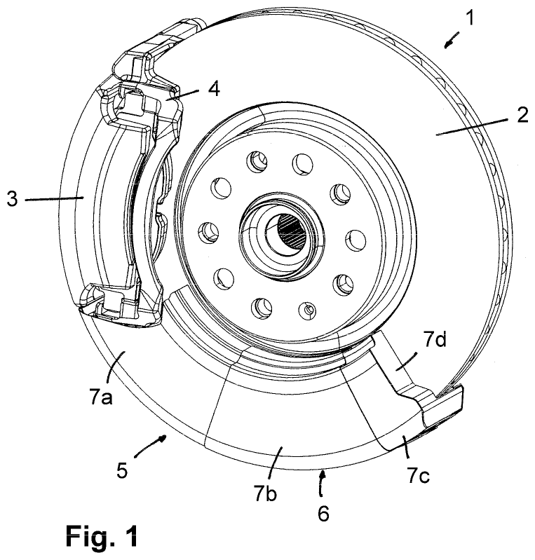

In FIG. 1, a disc brake 1 is illustrated which, as an example, can be used in a motor vehicle. The disc brake 1 comprises a brake disc 2 and a brake caliper 3 which is arranged at a brake caliper carrier 4. At the disc brake 1, there is a brake dust particle filter 5 that collects brake dust which is produced upon actuation of the disc brake by friction between the brake disc 2 and the brake pads at the brake disc. The brake dust particle filter 5 is preferably arranged downstream of the brake caliper 3 in rotational direction for forward travel.

The brake dust particle filter 5 comprises a filter housing 6 that is of a ring segment-shaped configuration and extends in the embodiment across an angle segment that lies in an angle range between 90° and 120°. The filter housing 6 is located at the radially outer side of the brake disc 2. The filter housing 6 comprises an approximately U-shaped cross section shape, wherein the two side walls of the filter housing 6 extend parallel to the two sides of the brake disc 2 and the radially outwardly positioned side of the filter housing 6 extends concentrically to the radially outer side of the brake disc 2.

The filter housing 6 accommodates a filter insert of a filter material at which the brake dust deposits. The filter insert can also comprise a U-shaped cross section shape.

As can be seen in FIG. 1 in connection with the additional Figures, the filter housing 6 is comprised of two housing parts 7 and 8 that form a first and a second housing half shell. The two housing half shells 7, 8 are connected to each other at their radially outwardly positioned side. Each housing half shell 7, 8 is comprised of a plurality of shell pieces, wherein the first housing half shell 7 comprises a total of four shell pieces 7a, b, c, d and the second housing half shell 8 comprises a total of two shell pieces 8a, b. Thus, the two housing half shells 7, 8 are each comprised of a plurality of shell pieces that form a filter housing assembly set and, depending on the installation position of the brake dust particle filter, can be assembled and connected to each other in different ways.

The two housing half shells 7 and 8 differ from each other. In order to be able to construct with minimal expenditure from a uniform filter housing assembly set the filter housing 6 illustrated in the Figures as well as a further filter housing that is mirror-symmetrically arranged thereto, in particular for an installation position in the vehicle at the left and right lateral region, a plurality of shell pieces 7a, b, c and 8a, b are mirror-symmetrically constructed. The mirror symmetry relates to a center plane that is illustrated in FIGS. 4 and 5, respectively, wherein due to the mirror symmetry the respective circumferential end regions of a shell piece are embodied mirror-symmetrically to each other. For example, the shell piece 7a is embodied mirror-symmetrically to its center plane so that its two oppositely positioned circumferential end regions are identically constructed and can be mirrored at the center plane.

The first housing half shell 7 comprises a total of three shell pieces 7a, 7b, and 7c that are each embodied mirror-symmetrically in relation to their center plane and correspondingly comprise mirror-symmetrically constructed circumferential end regions. In addition, an end face closure member is provided as a fourth shell piece 7d. The shell pieces 7a, b, and c are assembled in such a way that the shell piece 7a forms a first circumferential end face, the second shell piece 7b the centerpiece, and the third shell piece 7c the oppositely positioned circumferential end face. The circumferential shell pieces 7a and 7c differ in regard to their geometry from each other. For a mirror-symmetrical arrangement of the housing half shell 7, it is only required to interchange the circumferential shell pieces 7a and 7c with each other.

The second housing half shell with the shell pieces 8a and 8b comprises in principle a similar configuration. Both shell pieces 8a, 8b are also mirror-symmetrical embodied in relation to their center plane which is illustrated in FIG. 5. The two shell pieces 8a and 8b differ however in regard to their geometry from each other. In order to obtain a mirror-symmetrical arrangement of the filter housing, only the relative position of the two shell pieces 8a and 8b relative to each other must be interchanged.

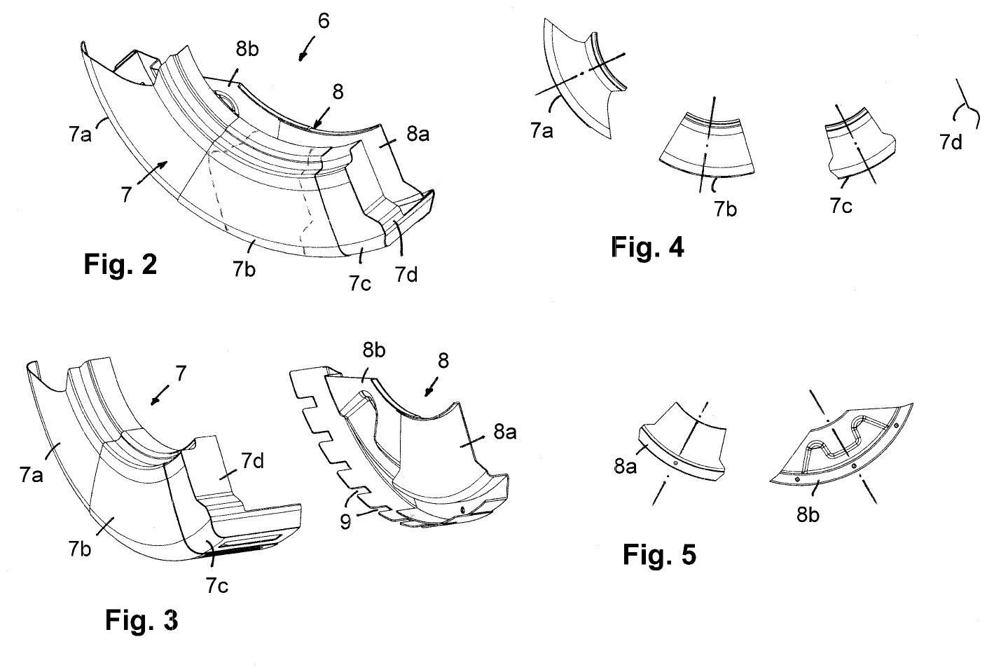

In order to obtain the housing half shell 7, the shell pieces 7a, b, c, d are joined and connected to each other in the sequence illustrated in FIG. 4. The same holds true for the second housing half shell 8 with the shell pieces 8a, b illustrated in FIG. 5. Upon joining and connecting, two respective adjoining shell pieces overlap each other in circumferential direction, as it is illustrated in FIG. 2 with the aid of the first housing half shell 7 with dashed line. The connection between the shell pieces 7a and 7b as well as between the shell pieces 7b and 7c is realized in the overlap region preferably by welding, wherein in principle also alternative connecting measures such as gluing or mechanical connecting measures such as screwing are conceivable. To the end face of the shell piece 7c, the terminal shell piece 7d is attached and connected to the shell piece 7c.

For the second housing half shell 8, the two shell pieces 8a and 8b are joined in an overlapping manner and preferably connected to each other in the overlap region. The connecting measures can be carried out in the same manner as for the first housing half shell 7.

After each housing half shell 7, 8 has been produced by joining the respective plurality of shell pieces, the filter housing can be produced by connecting the two housing half shells 7 and 8. The connection is realized in particular across the radially outwardly positioned side. Each housing half shell comprises a side wall and a radially outwardly positioned side in which flow openings 9 (FIG. 3) are introduced. Upon joining the two housing half shells 7 and 8, stays that are formed between the flow openings 9 and are provided at each housing half shell 7, 8 overlap each other in axial direction. The overlapping stays can be connected to each other.

What is claimed is:

1. A ring segment-shaped filter housing of a brake dust particle filter for collecting brake dust of a disc brake, the ring segment-shaped filter housing comprising:
a first housing part comprised of two or more first shell pieces connected to each other;
wherein the two or more first shell pieces overlap each other in a circumferential direction in an overlap region, respectively, and are connected to each other in the overlap region;
wherein at least one of the two or more first shell pieces comprises circumferential end regions that are mirror-symmetrical to each other.

2. The ring segment-shaped filter housing according to claim 1, wherein the two or more first shell pieces are welded to each other in the overlap region.

3. The ring segment-shaped filter housing according to claim 1, wherein the first housing part forms at least partially a side wall of the ring segment-shaped filter housing.

4. The ring segment-shaped filter housing according to claim 3, wherein one of the circumferential end regions of the at least one of the two or more first shell pieces forms a circumferential end piece of the side wall.

5. The ring segment-shaped filter housing according to claim 1, wherein the circumferential end regions of the at least one of the two or more first shell pieces comprise an interface geometry corresponding with a predetermined brake caliper of a disc brake assembly.

6. The ring-segment-shaped filter housing according to claim 1, further comprising a second housing part, wherein the first housing part forms a first housing half shell and the second housing part forms a second housing half shell, wherein the first housing half shell is comprised of the two or more first shell pieces connected to each other.

7. The ring segment-shaped filter housing according to claim 6, wherein the second housing half shell is comprised of two or more second shell pieces connected to each other, wherein at least one of the two or more second shell pieces of the second housing half shell comprises circumferential end regions that are mirror-symmetrical to each other.

8. The ring segment-shaped filter housing according to claim 7, wherein the first housing half shell differs from the second housing half shell in regard to a number, a shape and/or a size of the two or more first shell pieces compared to a number, a shape and/or a size of the two or more second shell pieces, respectively.

9. The ring segment-shaped filter housing according to claim 7, wherein the first housing half shell consists of precisely two of the first shell pieces.

10. The ring segment-shaped filter housing according to claim 7, wherein the second housing half shell consists of precisely two of the second shell pieces overlapping each other in the circumferential direction.

11. The ring segment-shaped filter housing according to claim 6, wherein the first housing half shell comprises at least three of the two or more first shell pieces overlapping each other in the circumferential direction, respectively.

12. The ring segment-shaped filter housing according to claim 7, wherein the two or more second shell pieces of the second housing part each comprise the circumferential end regions that are mirror-symmetrical to each other.

13. The ring segment-shaped filter housing according to claim 1, wherein the two or more first shell pieces of the first housing part each comprise the circumferential end regions that are mirror-symmetrical to each other.

14. A filter housing assembly set for producing a ring-segment-shaped filter housing according to claim 1, the filter housing assembly set comprising two or more shell pieces that are connectable to each other, wherein at least one of the two or more shell pieces comprises circumferential end regions that are mirror-symmetrical to each other, wherein the two or more shell pieces are configured to overlap each other in a circumferential direction in an overlap region, respectively, and to be connected to each other in the overlap region.

15. The filter housing assembly set according to claim 14, wherein the two or more shell pieces are configured to be welded to each other in the overlap region.

16. A brake dust particle filter for collecting brake dust of a disc brake, the brake dust particle filter comprising a ring segment-shaped filter housing according to claim 1 and further comprising a filter insert arranged in the ring segment-shaped filter housing.

17. A disc brake assembly comprising:
a brake disc;
a brake caliper arranged at the brake disc;
a brake dust particle filter arranged in a predetermined rotation direction downstream of the brake caliper in a circumferential direction of the brake disc and, at least in sections, engaging across the brake disc;
wherein the brake dust particle filter comprises a ring segment-shaped filter housing according to claim 1 and further comprises a filter insert arranged in the ring segment-shaped filter housing.

18. A disc brake assembly according to claim 17, wherein the end regions that are mirror-symmetrical to each other of the at least one of the two or more first shell pieces of the ring segment-shaped filter housing of the brake dust particle filter comprise an interface geometry corresponding with the brake caliper.
